(19) United States
(12) Patent Application Publication
(10) Pub. No.: US 2025/0201802 A1
(43) Pub. Date: Jun. 19, 2025

(54) ELECTRODE FOR NON-AQUEOUS ELECTROLYTE SECONDARY BATTERY, AND NON-AQUEOUS ELECTROLYTE SECONDARY BATTERY

(71) Applicant: MAXELL, LTD., Otokuni-gun, Kyoto (JP)

(72) Inventors: Kentaro Tomita, Otokuni-gun (JP); Hideaki Katayama, Otokuni-gun (JP); Haruki Kamizori, Otokuni-gun (JP)

(73) Assignee: MAXELL, LTD., Otokuni-gun, Kyoto (JP)

(21) Appl. No.: 18/844,563

(22) PCT Filed: Mar. 3, 2023
(86) PCT No.: PCT/JP2023/007930

§ 371 Date: Sep. 6, 2024

(30) Foreign Application Priority Data
Mar. 10, 2022 (JP) 2022-037576

(51) Int. Cl. H01M 4/131; H01M 4/02; H01M 4/485; H01M 4/62; H01M 10/0525; H01M 10/0562

(52) U.S. Cl. CPC H01M 4/131; H01M 4/485; H01M 4/62; H01M 10/0525; H01M 10/0562; H01M 2004/021; H01M 2004/027; H01M 2300/0068

(57) ABSTRACT

The electrode for a non-aqueous electrolyte secondary battery of the present invention has a molded body of an electrode composition containing at least particles of an electrode active material, a solid electrolyte, and particles of a conductive assistant. The volume-based particle size distribution of the particles of the electrode active material has two distributions: that is, a distribution of small particles with a diameter D₁ at the maximum frequency, and another distribution of large particles with a diameter D₂ at the maximum frequency. The volume fraction of the large particles is larger than the volume fraction of the small particles. The mode diameters D₃ of the particles of the conductive assistant obtained from the cross section and D₂ are D₃≤D₂. The average distance of the gravity centers between adjacent particles of the conductive assistant has a relationship of L≤D₂.

### TECHNICAL FIELD

The present invention relates to a non-aqueous electrolyte secondary battery having excellent output characteristics, and an electrode for constituting the non-aqueous electrolyte secondary battery.

### TECHNICAL BACKGROUND

The non-aqueous electrolyte secondary batteries are used for a portable electronic device such as portable telephones and notebook-sized personal computers, and a power supply of electric vehicles. Providing non-aqueous electrolyte secondary batteries to the society can contribute the achievement of Goal 3 (Ensure healthy lives and promote well-being for all at all ages), Goal 7 (Ensure access to affordable, reliable, sustainable and modern energy for all), Goal 11 (Make cities and human settlements inclusive, safe, resilient and sustainable) and Goal 12 (Ensure sustainable consumption and production patterns), among the seventeen lists of the sustainable developments goals (SDGs) established by the United Nations.

In current non-aqueous electrolyte secondary batteries, a lithium-containing composite oxide is usually used as the positive electrode active material, and graphite or the like is used as the negative electrode active material.

Furthermore, in non-aqueous electrolyte secondary batteries, various studies have been conducted to improve the characteristics; for example, attempts have been made to improve output characteristics and the like by adjusting the particle size and the like of the positive electrode active material (see e.g., Patent Documents 1 to 3).

Furthermore, in non-aqueous electrolyte secondary batteries from the viewpoint of improving reliability, a solid electrolyte has been used instead of a non-aqueous electrolyte (non-aqueous electrolyte solution) containing an organic solvent, which is a flammable substance (e.g., Patent Document 4).

### RELATED ART REFERENCES

### Patent References

Patent Reference No. 1: Japanese Laid-Open Patent Publication No. 2013-20736
Patent Reference No. 2: Japanese Laid-Open Patent Publication No. 2014-110176
Patent Reference No. 3: Japanese Laid-Open Patent Publication No. 2018-138513
Patent Reference No. 4: Japanese Laid-Open Patent Publication No. 2021-141007

### SUMMARY OF THE INVENTION

### The Objectives to Solve by the Invention

As described above, various improvements in the characteristics of non-aqueous electrolyte secondary batteries have been made. In recent years, however, there has been a demand for improving output characteristics such that a large capacity can be maintained even when discharging at a large current.

The present invention has been made in view of the above circumstances, and the object of the present invention is to provide a non-aqueous electrolyte secondary battery having excellent output characteristics, and to provide an electrode for constituting the non-aqueous electrolyte secondary battery.

### Means to Solve the Objectives

There is provided an electrode for a non-aqueous electrolyte secondary battery having a molded body of an electrode composition comprising at least particles of an electrode active material, a solid electrolyte, and particles of a conductive assistant, wherein the particles of an electrode active material has a volume-based particle size distribution comprising: two distributions, that are, a distribution of small particles having a diameter of maximum frequency D₁ (μm), and a distribution of large particles having a diameter of maximum frequency D₂ (μm), in which the volume-based particle size distribution is determined by observing a cross section of the molded body of the electrode composition, and wherein when an entire volume of the particles of the electrode active material is assumed to be 100%, the volume fraction of the large particles is larger than the volume fraction of the small particles, wherein when a mode diameter of the particles of the conductive assistant in the volume-based particle size distribution is D₃ (μm) which is obtained by observing the cross section, the following relation is satisfies D₃≤D₂, wherein when L_{d} (μm) is an inter-distance of gravity center obtained by arithmetic average of an Euclidean distance between a gravity center (i.e., geometric center. The same apply to the term “gravity center” in this specification.) of the particle of the conductive assistant obtained by observing the cross section, and each gravity center of a particle of the conductive assistant particle closest to the particle, a particle of the conductive assistant particle second closest to the particle, and a particle of the conductive assistant particle third closest to the particle, and when L (μm) is an average of the inter-distance of gravity center, L≤D₂ is satisfied.

Furthermore, the non-aqueous electrolyte secondary battery comprises a positive electrode, a negative electrode, and a separator or a solid electrolyte layer interposed between the positive electrode and the negative electrode, wherein at least one of the positive electrode and the negative electrode is the electrode for the non-aqueous electrolyte secondary battery of the present invention.

### Effects of the Invention

According to the present invention, it is possible to provide a non-aqueous electrolyte secondary battery having excellent output characteristics, and an electrode for constituting the non-aqueous electrolyte secondary battery.

### BRIEF DESCRIPTION OF THE DRAWINGS

FIG. 1 is a cross-sectional view schematically showing an example of a non-aqueous electrolyte secondary battery of the present invention.

FIG. 2 is a plan view schematically showing another example of the non-aqueous electrolyte secondary battery of the present invention.

FIG. 3 is a cross-sectional view taken along line I-I of FIG. 2.

### EMBODIMENTS TO CARRY OUT THE INVENTION

### <Electrode for Non-Aqueous Electrolyte Secondary Battery>

The electrode for non-aqueous electrolyte secondary battery of the present invention (which hereinafter may be simply referred to as “electrode”) has a molded body of an electrode composition containing at least particles of an electrode active material, a solid electrolyte, and particles of a conductive assistant (such as a layer of an electrode composition (i.e., electrode composition layer) formed on a current collector, or one consisting of a molded body of an electrode composition (pellets, etc.)), and the volume-based particle size distribution of the particles of the electrode active material obtained by observing the cross section of the molded body of the electrode composition has two distributions, which belong to small particles with a diameter of D₁ (μm) at the maximum frequency, and large particles with a diameter of D₂ (μm) at the maximum frequency. In this way, when the particles of the electrode active material present in the molded body of the electrode composition have a bimodal morphology in their volume-based particle size distribution, with two frequency peaks on the small particle size side and the large particle size side, it is possible that the density of the molded body of the electrode composition becomes high and the materials constituting the electrode composition can form a good contact state and interface with each other. When the particle size distribution contains small particles and large particles, it is possible to ensure the same effects as those in the particle size distribution having a bimodal morphology. As a result, the ionic conductivity and electronic conductivity can be improved, thereby increasing the utilization rate of the electrode active material inside the molded body of the electrode composition, and therefore improving the effect of increasing the energy density of the electrode and the effect of improving the input/output characteristics.

That an electrode contains large particles and small particles as particles of an electrode active material can be confirmed by the satisfaction of the relationships of: the degree of freedom-adjusted determination coefficient (corrected R-squared) being greater than 0.97, and D₂≥1.5×D₁, wherein the degree of freedom-adjusted determination coefficient (corrected R-squared) is obtained by fitting with two log-normal distribution functions that share a standard deviation value with respect to the particle size distribution obtained by observing a cross section of the electrode, wherein each of D₁ and D₂ is a ratio of the diameter as explained before.

In the particles of the electrode active material, the diameter D₁ is preferably 0.1 μm or more, more preferably 0.2 μm or more, and is preferably 10 μm or less, and more preferably 6 μm or less, and the diameter D₂ is preferably 0.5 μm or more, more preferably 0.8 μm or more, and is preferably 40 μm or less, and more preferably 30 μm or less. The difference between the diameter D₁ and the diameter D₂ is preferably 0.4 to 30 μm.

Regarding the electrode active material of the molded body in the electrode composition, as the proportion of the small particles with smaller particle diameters increases, the amount of the conductive assistant required to distribute electrons throughout the electrode active material increases. However, as the amount of the conductive assistant increases, the ion conductivity in the molded body of the electrode composition is hindered, thereby decreasing the output characteristics of the electrode, and ultimately decreasing the output characteristics of the non-aqueous electrolyte secondary battery using the electrode. Therefore, in the present invention from the viewpoint of improving the output characteristics of the battery, the volume fraction of the large particles is made larger than the volume fraction of the small particles in the volume-based particle size distribution of the electrode active material particles in the electrode, when the entire volume of the electrode active material particles is assumed 100%.

In the electrode active material, the volume fraction of the small particles is preferably 3 vol. % or more, and more preferably 8 vol. % or more, from the viewpoint of further improving the output characteristics of the electrode, and it is preferably 50 vol. % or less, and more preferably 25 vol. % or less, from the viewpoint of increasing the density and durability of the molded body of the electrode composition. All particles other than those belonging to the small particles of the electrode active material are to belong to the large particles. Thus, the volume fraction of the large particles in the electrode active material is preferably 50 vol. % or more, more preferably 75 vol. % or more, preferably 97 vol. % or less, and more preferably 92 vol. % or less.

The conductive assistant (the details thereof will be described later) that can be contained in the molded body of the electrode composition is present in the form of primary particles or aggregate particles (secondary particles) in the molded body of the electrode composition. The mode diameter D₃ (μm) in the volume-based particle size distribution of the conductive assistant particles can be determined by observing the same cross section of the molded body of the electrode composition, which was used to determine the volume-based particle size distribution of the electrode active material. The mode diameter D₃ (μm) has a relationship with the diameter D₂ of the particles of the electrode active material, which satisfies D₃≤D₂. Since the molded body of the electrode composition contains particles of the conductive assistant having a particle size specified in this manner, a short-distance conductive path is well formed within the molded body, thereby improving the output characteristics of the electrode (which eventually improves the output characteristics of the non-aqueous electrolyte secondary battery).

The diameter D₃ is preferably 0.01 μm or more, more preferably 0.1 μm or more, and is preferably 40 μm or less, more preferably 30 μm or less.

Furthermore, L_{d} (μm) is an arithmetic average value of: the Euclidean distance L₁ between the gravity center of a conductive assistant particle “a” and the gravity center of the conductive assistant particle closest to the particle “a”; the Euclidean distance L₂ between the center of gravity of the particle “a” and the center of gravity of the conductive assistant particle second closest to the particle “a”; and the Euclidean distance L₃ between the center of gravity of the particle “a” and the center of gravity of the conductive assistant particle third closest to the particle “a”. An inter-distance of gravity center L (μm) is an arithmetic average value of L_{d} (μm). The molded body of the electrode composition satisfies the relationship L≤D₂. For example, if the amount of the conductive assistant particles in the molded body of the electrode composition is too small, the distance L becomes long and the formation of the conductive network by the contact between the conductive assistants becomes insufficient. However, if the distance L is the same as or shorter than the diameter D₂, the conductive assistant particles can form good contacts with each other in the molded body of the electrode composition, thereby well forming a conductive network to improve the output characteristics of the electrode (which eventually improves the output characteristics of the non-aqueous electrolyte secondary battery).

The distance L is preferably 0.01 μm or more, more preferably 0.1 μm or more, and is preferably 40 μm or less, more preferably 30 μm or less.

In this specification, the volume-based particle size distribution of the particles of the electrode active material in the molded body of the electrode composition can be obtained by sampling all particles identified as the electrode active material among the particles captured by a scanning electron microscope (SEM) image (magnification: 5,000 times) at any multiple locations on the cross section of the molded body of the electrode composition prepared by focused ion beam (FIB) processing. The number of observation fields is set such that 5.000 or more particles of the electrode active material are observed. The particles of the electrode active material in the SEM image can be confirmed by any one of energy dispersive X-ray spectroscopy (EDS) mapping analysis, electron probe microanalyzer (EPMA) analysis, and time-of-flight secondary ion mass (TOF-SIMS) mapping analysis. The apparent particle size D′(n) of the nth particle of the electrode active material is equal to the diameter of a circle having an area equivalent to the cross-sectional area of the nth particle of the electrode active material. Taking into consideration that the average diameter of a circle in the cross-section when a sphere is cut at an arbitrary depth from the outermost surface is √(2/3) times the diameter D of the sphere, the particle size D(n) [=D′(n)/√(2/3)] of the nth particle of the electrode active material is calculated. A volume-based particle size distribution (histogram) can be obtained by multiplying the frequency of each particle size, as obtained, by the volume V(n) of each particle, followed by dividing the result by the sum of V(n).

Image analysis software can be used to perform sampling of the electrode active material particles. Specifically, the contrast histogram of the image is analyzed using “ImageJ,” and a contrast region to which particles of the electrode active material belong is selected by the EDS mapping analysis or the like, and the image is binarized. The binarized image is subjected to the shrinkage and expansion processes in the above order twice, followed by carrying out a Fill Halls process once and a shrinkage process once, followed by dividing adjacent particles at the watershed. By analyzing particles with an area of 0.005 (μm²) or more using Analyze Particles, it is possible to do a sampling of more than 5,000 particles (particles on the edge of the image are excluded).

The volume-based particle size distribution of the electrode active material thus obtained is fitted with two log-normal distribution functions that share a standard deviation value using graph creation software such as “Origin (product name)” manufactured by OriginLab Corporation, to determine the diameters D₁ and D₂. The volume fraction of the small particles and the volume fraction of the large particles can be obtained by dividing the peak area on the small particle side and the peak area on the large particle side, respectively, by the sum of the areas of the two peaks obtained by the fitting operation.

The conductive assistant particles can be analyzed in the same manner as the electrode active material particles to obtain the mode diameter D₃ of the conductive assistant particles, except that the operation of dividing adjacent particles at the watershed on the binarized image is not performed.

The average distance L between the centers of gravity of the conductive assistant particles can be obtained by analyzing the data list. That is, analysis is carried out for the data list of the particle number and the orthogonal coordinates of the center of gravity (i.e., geometric center) of each particle obtained by performing Analyze Particles, with respect to the image of each particle obtained by binarizing the image of each particle obtained by image analysis using ImageJ to obtain D₃. The data list and the scikit-learn package are imported into Python, and the Euclidean distance between the three nearest particles (k=3) for each particle is calculated by using the k-nearest neighbor algorithm, and the result is output as a data list. In this case, overlapping between adjacent particles is allowed. The arithmetic mean interparticle distance L is obtained from the data list. When the particles are monodispersed and packed nearly in the closest manner, the number of first adjacent particles is equal to k=6. However, taking into consideration that an actual electrode contains particles of a solid electrolyte and an electrode active material, L is to be calculated under the condition of k=3 in order to prioritize the analysis of the distance between adjacent particles. Even if the value of k is from 1 to 6, it does not affect the essence of the present invention.

Each value of D₁, D₂, D₃ and L described in the Examples later is determined by the above-mentioned method.

The electrode of the present invention can be used as at least one of the positive electrode and the negative electrode in various non-aqueous electrolyte secondary batteries, such as solid electrolyte secondary batteries (such as all-solid-state secondary batteries) having a solid electrolyte layer, and secondary batteries having a non-aqueous electrolyte (such as a non-aqueous electrolyte solution) and a separator interposed between a positive electrode and a negative electrode.

The electrode of the present invention has a molded body of an electrode composition containing particles of an electrode active material, a solid electrolyte, and particles of a conductive assistant. Examples of the electrode include an electrode consisting of a molded body (pellet, etc.) of the electrode composition, and an electrode having a structure in which a layer (electrode composition layer) consisting of a molded body of the electrode composition is formed on a current collector.

When the electrode is used as a positive electrode of a non-aqueous electrolyte secondary battery, the particles of the electrode active material can be particles of an active material capable of absorbing and releasing lithium ions, similar to those used in conventionally known lithium ion secondary batteries. Specifically, the examples thereof can include: a spinel-type lithium manganese composite oxide represented by LiMᵣMn₂₋ᵣO₄ (wherein M is at least one element selected from the group consisting of Li, Na, K, B, Mg, Ca, Sr, Ba, Ti, V, Cr, Zr, Fe, Co, Ni, Cu, Zn, Al, Sn, Sb, In, Nb, Ta, Mo, W, Y, Ru, and Rh, and 0≤r≤1); a layered compound represented by LiᵣMn₍₁₋ₛ₋ᵣ₎NiₛMₛO₍₂₋ᵤ₎Fᵥ (where M is at least one element selected from the group consisting of Co, Mg, Al, B, Ti, V, Cr, Fe, Cu, Zn, Zr, Mo, Sn, Ca, Sr, and W, and 0.8≤r≤1.2, 0<s<0.5, 0≤t≤0.5, u+v<1, −0.1≤u≤0.2, 0≤v≤0.1); a lithium cobalt composite oxide represented by LiCo₁₋ᵣMᵣO₂ (where M is at least one element selected from the group consisting of Al, Mg, Ti, V, Cr, Zr, Fe, Ni, Cu, Zn, Ga., Ge, Nb, Mo, Sn, Sb, and Ba, and 0≤r≤0.5); a lithium nickel composite oxide represented by LiNi₁₋ᵣMᵣO₂ (where M is at least one element selected from the group consisting of Al, Mg, Ti, Zr, Fe, Co, Cu, Zn, Ga, Ge, Nb, Mo. Sn, Sb and Ba, and 0≤r≤0.5); an olivine type composite oxide represented by Li₁₊ₛM₁₋ᵣNᵣPO₄F₅ (where M is at least one element selected from the group consisting of Fe, Mn and Co, and N is at least one element selected from the group consisting of Al, Mg, Ti, Zr, Ni, Cu, Zn, Ga, Ge, Nb, Mo, Sn, Sb, V and Ba, and 0≤r≤0.5, 0≤s≤1); and a pyrophosphate compounds represented by the formula Li₂M₁₋ᵣNᵣP₂O₇ (wherein M is at least one element selected from the group consisting of Fe, Mn, and Co, and N is at least one element selected from the group consisting of Al, Mg, Ti, Zr, Ni, Cu, Zn, Ga, Ge, Nb, Mo, Sn, Sb, V, and Ba, and 0≤r≤0.5). These may be used alone or in combination. These are particles of various positive electrode active materials used in conventionally known non-aqueous electrolyte secondary batteries.

In an electrode (positive electrode) having a molded body of an electrode composition (positive electrode composition) containing particles of a positive electrode active material and a solid electrolyte, if the particles of the positive electrode active material come into direct contact with the solid electrolyte, the solid electrolyte might oxidize to form a resistance layer to decrease the ionic conductivity within the molded body. If the ionic conductivity within the molded body of the positive electrode composition decreases for this reason, there is a risk, for example, that the output characteristics of a non-aqueous electrolyte secondary battery using such a positive electrode might be impaired.

In view of this, it was proposed to provide a reaction suppression layer on the surface of the particles of the positive electrode active material to suppress the reaction with the solid electrolyte, as described in, e.g., Patent Document 4. The reaction suppression layer prevents direct contact between the particles of the positive electrode active material and the solid electrolyte, thereby suppressing a decrease in ionic conductivity within the molded body due to the side reactions such as oxidation of the solid electrolyte, thereby suppressing a decrease of the battery output characteristics.

However, it was found that it is not easy to completely cover the surfaces of the particles of the positive electrode active material with a reaction suppression layer, and there is a risk of the side reactions of the solid electrolyte occurring in the areas where the reaction suppression layer is not formed. For these reasons, there is a limited effect in improving the output characteristics of a battery by forming a reaction suppression layer on the surface of particles of a positive electrode active material.

Therefore, when the electrode is used as a positive electrode of a non-aqueous electrolyte secondary battery, it is preferable to use a spinel-type positive electrode active material represented by the following composition formula (1) for the electrode active material (positive electrode active material) relating to particles of the electrode active material (positive electrode active material).

LiₐA_{b}Mn_{2-x-y}M¹ₓM²_{y}O_{4-δ} (1)

In the composition formula (1), M¹ is at least one element of Ni and Co, M² is at least one element selected from the group consisting of Al Mg, Ca, Ti, Cr, Fe, Cu, Zn, La, Ce, Er, and Li, A is at least one element selected from the group consisting of Mg, Al, Nb, Ta, Ni, Mn, and Co, and 0≤a≤2-b, 0≤b≤0.15, 0.4≤x≤1.1, 0≤y≤0.55, and 0≤δ≤0.5.

Such a spinel-type positive electrode active material is unlikely to cause a side reaction with the solid electrolyte, and therefore it is possible to suppress a decrease in ion conductivity in the molded body of the positive electrode composition caused by the side reaction. Therefore, better output characteristics can be obtained in a non-aqueous electrolyte secondary battery formed by using a positive electrode having a molded body of a positive electrode composition containing the spinel-type positive electrode active material and a solid electrolyte.

Furthermore, the spinel-type positive electrode active material is not only less likely to undergo side reactions with the solid electrolyte, but also has the effect of enhancing the output characteristics of the battery. Therefore, for example, in a non-aqueous electrolyte secondary battery including a positive electrode having a molded body of a positive electrode composition (such as a positive electrode composition layer) that contains the spinel-type positive electrode active material and does not contain a solid electrolyte, and a non-aqueous electrolyte other than the solid electrolyte, such as a non-aqueous electrolyte solution, the output characteristics are improved.

The element M¹ in the composition formula (1) is a component that contributes to improving the capacity of the spinel-type positive electrode active material, and its amount x is preferably 0.4 or more, and more preferably 0.45 or more. In the spinel-type positive electrode active material represented by the composition formula (1), if the amount of the element M¹ is too large, the amount of other components (e.g., Mn) becomes small, and there is a risk that the action of the other components cannot be sufficiently ensured. Therefore, the amount x of the element M¹ in the composition formula (1) is 1.1 or less, and preferably 1.05 or less.

Mn in the composition formula (1) is, for example, a component that contributes to improving the thermal stability of the spinel-type positive electrode active material. Furthermore, stabilizing the average valence of Mn to a value close to 4 improves the reversibility of the spinel-type positive electrode active material during charging and discharging of the battery.

The spinel-type positive electrode active material represented by the composition formula (1) may or may not contain the element M². That is, the amount y of element M² in the composition formula (1) is 0 or more. However, if the amount of element M² is too large, the amounts of other components will be reduced. Therefore, the amount y is 0.55 or less, and preferably 0.2 or less.

In the spinel-type positive electrode active material represented by the composition formula (1), oxygen deficiency may or may not occur, but S, which represents the amount of oxygen deficiency, is 0 or more and 0.5 or less.

Furthermore, in the composition formula (1), a, which represents the amount of Li, is preferably 0 or more and 2 or less, and from the viewpoint of maintaining a cubic spinel type crystal structure, it is preferably 0 or more and 1.3 or less.

In the composition formula (1), element A is an element added to an empty Li site, and b, which represents the amount of element A, is 0 or more, and is preferably 0.15 or less from the viewpoint of maintaining a cubic spinel crystal structure.

The composition of the spinel-type positive electrode active material contained in the molded body of the electrode composition can be determined, for example, by observing the cross section of the positive electrode with an SEM and analyzing the active material particle locations by using EDS (the composition of the spinel-type positive electrode active material described in the Examples was determined by this method). In addition, the composition can be determined by TOF-SIMS analysis of the cross section of the electrode, or by taking a sample piece from the cross section of a molded body of the electrode composition and determining the composition by a method in which a transmission electron microscope (TEM) is combined with various elemental analysis methods such as EDS and a wavelength dispersive X-ray spectrometer (WDS).

In addition, the fact that the positive electrode active material is a spinel type can be confirmed by adjusting the voltage of the positive electrode to 3 V based on the lithium electrode, thereby obtaining an XRD pattern of the positive electrode by comparing it with the JCPDS card (No. 80-2162).

When a=1 in the composition formula (1), the ratio of Mn³⁺ to the total Mn amount in the electrode is preferably 6% or less, more preferably 4.5% or less, and can be 0% (all Mn is tetravalent) (i.e., when the total Mn amount is 100 mol %, the ratio of Mn³⁺ is preferably 6 mol % or less, more preferably 4.5 mol % or less, and can be 0 mol %). In this case, it is possible to further suppress side reactions of the solid electrolyte caused by contact with the spinel-type positive electrode active material. In addition, since the average valence of Mn contained in the spinel-type positive electrode active material is 4 or becomes close to 4, the reversibility of the spinel-type positive electrode active material during charging and discharging of the battery is also improved.

The ratio of Mn³⁺ to the total amount of Mn contained in the spinel oxide is determined from the Mn—K edge rising position in X-ray absorption near edge structure (XANES) measurement. MnO is selected as a standard sample of Mn²⁺, Mn₃O₄ is selected as a standard sample of Mn²⁺/Mn³⁺=½, and Mn₂O₃ is selected as a standard sample of Mn³⁺, and each is diluted with boron nitride to prepare pellets. The prepared pellets are sealed in a sealed measurement cell having a polyimide window, and a XANES spectrum is obtained by a transmission method. The Mn—K absorption edge onset position is determined, and a calibration curve is prepared by plotting the Mn valence of the standard sample on the horizontal axis and the absorption edge onset position on the vertical axis. The ratio of Mn to the total amount of Mn contained in the spinel-type oxide contained as a component of the positive electrode is obtained by disassembling a battery in a discharged state (a state in which the depth of charge is 0 to 5%) in an inert atmosphere, scraping off the positive electrode, diluting it with boron nitride in the same manner as in the case of the standard sample to prepare a pellet, performing XANES measurement, determining the onset position of the Mn—K absorption edge, and determining the average valence of Mn using a calibration curve, thereby obtaining the ratio of Mn³⁺ to the total amount of Mn.

In addition, from the viewpoint of suppressing side reactions of the solid electrolyte, it is desirable for the spinel type positive electrode active material to be of a disordered type. The X-ray diffraction pattern of a spinel-type positive electrode active material is usually found in the space group Fd-3m, but when it contains at least a portion of an ordered component, the X-ray diffraction pattern may be indexed to the space group P4₃32. The spinel-type positive electrode active material is a disordered type when, in the X-ray diffraction pattern of the electrode when a=1 in the composition formula (1), a pattern of the electrode active material is indexed by the space group P4₃32, the ratio I₍₁₁₀₎/I₍₂₂₀₎ of the intensity I₍₂₂₀₎ of the peak belonging to (220) to the intensity I₍₁₁₀₎ of the peak belonging to (110) is preferably less than 1, and may be 0.

The I₍₁₁₀₎/I₍₂₂₀₎ of the spinel-type positive electrode active material is obtained as follows: A battery in a discharged state (a state in which the depth of charge is 0) is disassembled in an inert atmosphere, and if the electrode (positive electrode) has a current collector, the current collector is removed to expose the molded body of the electrode composition (the molded body of the positive electrode composition), which is processed to be flat. Then, the sample is fixed to the flat part of a sample plate corresponding to a thick sample piece with the height of the flat part of the sample aligned, and the sample plate is fixed in an airtight cell with a beryllium window, and a powder X-ray diffraction pattern is obtained and indexed to obtain an I₍₁₁₀₎/I₍₂₂₀₎.

The spinel-type positive electrode active material can be manufactured through a process of preparing a precursor by mixing raw material compounds such as an Li-containing compound (lithium carbonate, lithium hydroxide, etc.), an element M¹-containing compound (oxide, hydroxide, sulfate, etc.), an Mn-containing compound (oxide, hydroxide, sulfate, etc.), and an element A and an element M²-containing compound (oxide, hydroxide, sulfate, etc.) if needed, and a process of calcining this precursor. Since the calcination produces large lumps of spinel-type positive electrode active material, a crushing process is then carried out to crush the lumps of spinel-type positive electrode active material.

In addition, when mixing the raw material compounds, it is usually desirable to increase the density of the precursor by mixing the raw material compounds with a relatively large shear or by going through a process of dissolving the raw material compounds using a solvent, from the viewpoint of increasing the reactivity between the raw material compounds during firing and increasing the purity of the obtained positive electrode active material. However, when a precursor with a high density is used for firing, the resulting lumps of spinel-type positive electrode active material become hard, and it becomes necessary to apply a large shear force during crushing. This results in a large amount of fine powder with a very small particle size being formed in the crushed material. If attempting to suppress the formation of fine powder, it results in forming coarse particles.

Therefore, when the raw material compounds are mixed, it is preferable to mix them while incorporating air, so as to reduce the bulk density of the resulting precursor. When such a precursor is fired, the resulting agglomerates of the spinel-type positive electrode active material become brittle, and therefore it becomes possible to crush them by applying a small shear, thereby making it easy to adjust the particle size of the spinel-type positive electrode active material to the above-mentioned range while suppressing the generation of fine powder or coarse particles.

In the manufacture of the spinel-type positive electrode active material, the firing temperature is preferably set to 1100 to 800° C., and the firing time is preferably set to 1 to 24 hours.

In the production of the spinel-type positive electrode active material, a reoxidation step of heating the agglomerates of the spinel-type positive electrode active material can be provided between the precursor firing step and the subsequent crushing step. Even in the case of a spinel-type positive electrode active material in which the proportion of Mn³⁺ in the total Mn does not satisfy the above-mentioned value simply by undergoing the firing step and the crushing step, it is possible to adjust the proportion of Mn³⁺ in the total Mn to the above-mentioned value by performing the reoxidation step after the step of firing and before the step of crushing.

Depending on the heating conditions in the reoxidation step, ordering of the spinel-type positive electrode active material may progress, leading to a possibility that the value of I₍₁₁₀₎/I₍₂₂₀₎ may become large. Therefore, it is preferable that the heating in the reoxidation step is performed under the conditions that can reoxidize the spinel-type positive electrode active material to reduce the proportion of Mn³⁺ while maintaining the spinel-type positive electrode active material in a disordered form. Specifically, it is preferable to carry out the reoxidation at a temperature of 655 to 495° C., for a period of 10 to 100 hours. Also, the reoxidation step can be carried out at a constant heating temperature, or by changing the heating temperature in multiple stages (two stages, three stages, etc.) within the range satisfying the above temperature.

In the case where the electrode is a positive electrode, particles of the electrode active material (positive electrode active material) can be provided with a reaction suppression layer on the surface thereof to suppress a reaction with the solid electrolyte, from the viewpoint of better suppression of the side reactions of the solid electrolyte.

The reaction suppression layer can be made of a material that has ion conductivity and can suppress the reaction between the particles of the electrode active material (positive electrode active material) and the solid electrolyte. Examples of materials that can form the reaction suppression layer include oxides containing L₁ and at least one element selected from the group consisting of Nb, P, B, Si, Ge, Ti, Zr, Ta, and W, more specifically, e.g., Nb-containing oxides such as LiNbO₃, Li₃PO₄, Li₃BO₃, Li₄SiO₄, Li₄GeO₄, LiTiO₃, LiZrO₃, and Li₂WO₄. The reaction suppression layer can contain only one of these oxides, or two or more of these oxides, which further can form a composite compound of two or more of these oxides. Among these oxides, it is preferable to use an Nb-containing oxide, and it is more preferable to use LiNbO₃.

The reaction suppression layer is preferably present on the surface in an amount of 0.1 to 2.0 parts by mass per 100 parts by mass of the electrode active material. Within this range, the reaction between the particles of the electrode active material and the solid electrolyte can be effectively suppressed.

The methods for forming a reaction suppression layer on the surface of particles of an electrode active material include the sol-gel method, mechanofusion method, CVD method, PVD method, and ALD method.

When the electrode composition (positive electrode composition) contains particles of a spinel-type positive electrode active material represented by the composition formula (1) as particles of the electrode active material, the ratio of the particles of the spinel-type positive electrode active material in the total amount of particles of the electrode active material is preferably 85 mass % or more, and more preferably 100 mass % (i.e., all are particles of the spinel-type positive electrode active material).

When the electrode is a positive electrode, the content of the particles of the electrode active material (positive electrode active material) in the electrode composition (positive electrode composition) is preferably 20 to 95 mass %.

When the electrode of the present invention is a negative electrode, examples of the particles of the negative electrode active material include: particles of carbon materials such as graphite; simple substances containing an element such as Si. Sn, Ge, Bi, Sb, and In, and a compounds (oxides, etc.) and an alloy thereof; a compound that can be charged and discharged at a low voltage close to lithium metal, such as lithium-containing nitrides or lithium-containing oxides (lithium titanium oxides such as Li₄Ti₅O₁₂); and the like. Furthermore, particles of lithium metal or lithium alloys (such as lithium-aluminum alloys and lithium-indium alloys) can also be used as particles of the negative electrode active material.

When the electrode is a negative electrode, the content of the particles of the electrode active material (negative electrode active material) in the electrode composition (negative electrode composition) is preferably 10 to 99 mass %.

The electrode composition contains particles of a conductive assistant. Specific examples thereof include carbon materials such as graphite (natural graphite and artificial graphite), graphene, carbon black, carbon nanofibers, and carbon nanotubes. The content of the conductive assistant particles in the electrode composition is preferably 1 to 15 mass %.

The electrode composition contains a solid electrolyte. The solid electrolyte is not particularly limited as long as it has a L₁ ion conductivity. For example, a sulfide-based solid electrolyte, a hydride-based solid electrolyte, a halide-based solid electrolyte, an oxide-based solid electrolyte, etc. can be used.

Examples of sulfide-based solid electrolytes include particles of Li₂S—P₂S₅, Li₂S—SiS₂, Li₂S—P₂S₅—GeS₂, and Li₂S—B₂S₃-based glass. Additionally, the example that have been attracting attention in recent years for their high Li-ion conductivity can include: thio-LISICON-type electrolytes such as Li₁₀GeP₂S₁₂, Li_{9.54}Si_{1.74}P_{1.44}S_{11.7}Cl_{0.3}, etc., which can be expressed as Li_{12-12a-b+x+6d-e}M¹_{3+a-b-c-d}M²_{b}M³_{c}M⁴_{d}M⁵₁₂₋ₑXₑ (where M¹ is Si, Ge or Sn, M² is P or V, M³ is Al, Ga, Y or Sb, M⁴ is Zn, Ca or Ba, M⁵ is S or S and O, and X is F, Cl, Br or I, 0≤a<3, 0≤b+c+d≤3, 0≤e≤3); and an argyrodite type compound such as Li₆PS₅Cl, which can be expressed as Li_{7-f+g}PS₆₋ₓCl_{x+y}, (where 0.05≤f≤0.9, −3.0f+1.85≤g≤−3.0f+5.7), and Li₇₋ₕPS₆₋ₕClᵢBrⱼ(where h=i+j, 0<h≤1.8, 0.1≤i/j≤10.0)) can also be used.

Examples of a hydride-based solid electrolytes include LiBH₄, solid solutions of LiBH₄ and the following alkali metal compounds (for example, those in which the molar ratio of LiBH₄ to the alkali metal compound is 1:1 to 20:1), and the like. An alkali metal compound in the solid solution can be at least one selected from the group consisting of lithium halides (LiI, LiBr, LiF, LiCl, etc.), rubidium halides (RbI, RbBr, RbF, RbCl, etc.), cesium halides (CsI, CsBr, CsF, CsCl, etc.), lithium amide, rubidium amide, and cesium amide.

Examples of halide-based solid electrolytes include monoclinic LiAlCl₄, defective spinel or layered structure LiInBr₄, and monoclinic Li₆₋₃ₘYₘX₆ (where 0<m<2 and X=Cl or Br), and other known solid electrolytes that can be used include those described in, for example, WO 2020/070958 and WO 2020/070955.

Examples of oxide-based solid electrolytes include Li₂O—Al₂O₃—SiO₂—P₂O₅—TiO₂ type glass ceramics, Li₂O—Al₂O₃—SiO₂—P₂O₅—GeO₂ type glass ceramics, garnet-type Li₇La₃Zr₂O₁₂, NASICON type Li₁₊ₒAl₁₊ₒTi₂₋ₒ(PO₄)₃, Li₁₊ₚAl₁₊ₚGe₂₋ₚ(PO₄)₃, and perovskite type Li_{3q}La_{2/3-q}TiO₃.

Among these solid electrolytes, sulfide-based solid electrolytes are preferred because of their high Li ion conductivity, sulfide-based solid electrolytes containing Li and P are more preferred, and argyrodite-type sulfide-based solid electrolytes, which have particularly high Li ion conductivity and high chemical stability, are even more preferred.

From the viewpoint of reducing grain boundary resistance, the average particle size of the solid electrolyte is preferably 0.1 μm or more, and more preferably 0.2 μm or more, while from the viewpoint of forming a sufficient contact interface between the positive electrode active material and the solid electrolyte, the average particle size is preferably 10 μm or less, and more preferably 5 μm or less.

The average particle diameter of the solid electrolyte as used herein means the 50% diameter value (D₅₀) in the volume-based integrated fraction when the integral volume is determined from particles with small particle sizes using a particle size distribution measurement device (such as a Microtrac particle size distribution measurement device “HRA9320” manufactured by Nikkiso Co., Ltd.).

When the electrode is a positive electrode, the content of the solid electrolyte in the electrode composition (positive electrode composition) is preferably 4 to 80 mass %. When the electrode is a negative electrode, the content of the solid electrolyte in the electrode composition (negative electrode composition) is preferably 4 to 85 mass %.

The electrode composition can contain a binder. Specific examples include fluororesins such as polyvinylidene fluoride (PVDF). In addition, for example, when a sulfide-based solid electrolyte is contained in the electrode material, if good moldability can be ensured in forming a molded body of the electrode material without using a binder, the electrode composition does not need to contain a binder.

When a binder is required in the electrode composition, the content thereof is preferably 15% by mass or less, and is preferably 0.5% by mass or more. On the other hand, in the case where the electrode composition contains a sulfide-based solid electrolyte and thus can obtain formability without the need for a binder, the content is preferably 5 mass % or less, more preferably 0.3 mass % or less, and even more preferably 0 mass % (i.e., no binder is contained).

When the electrode is a positive electrode and has a current collector, the current collector can be made of a metal foil, a punched metal, a mesh, an expanded metal, or a foamed metal of e.g., aluminum, nickel or stainless steel; or a carbon sheet. Furthermore, when the electrode is a negative electrode and has a current collector, the current collector can be a foil, punched metal, net, expanded metal or foamed metal made of copper or nickel; carbon sheet; or the like.

The molded body of the electrode composition can be formed, for example, by compressing, by pressure molding, an electrode composition prepared by mixing particles of the electrode active material, a solid electrolyte, particles of a conductive assistant, and the like.

In the case of an electrode having a current collector, the electrode can be produced by bonding a molded body of the electrode composition formed by the above-mentioned method to the current collector by means of, for example, pressure bonding.

Also, the electrode composition and a solvent can be mixed to prepare a electrode composition mixture, which is then applied to a substrate such as a current collector or a solid electrolyte layer (when the non-aqueous electrolyte secondary battery using the electrode is an all-solid-state secondary battery) that faces the electrode, dried, and then pressed to form a molded body of the electrode composition.

It is preferable to select a solvent for the composition containing the electrode composition mixture that does not easily deteriorate the solid electrolyte. In particular, since sulfide-based solid electrolytes and hydride-based solid electrolytes undergo chemical reactions in the presence of minute amounts of water, it is preferable to use non-polar aprotic solvents such as hydrocarbon solvents such as hexane, heptane, octane, nonane, decane, decalin, toluene, xylene, mesitylene, and tetralin. In particular, it is more preferable to use an ultra-dehydrated solvent having a water content of 0.001% by mass (10 ppm) or less. In addition, the example thereof to be used can include fluorine-based solvents such as “Vertrel (registered trademark)” manufactured by Du Pont-Mitsui Fluorochemicals Co. Ltd., “Zeorolla (registered trademark)” manufactured by Zeon Corporation, and “Novec (registered trademark)” manufactured by Sumitomo 3M Limited, as well as non-aqueous organic solvents such as dichloromethane, diethyl ether, and anisole,

The thickness of the molded body of the electrode composition (in the case of an electrode having a current collector, the thickness of the molded body of the electrode composition per one side of the current collector; the same applies hereinafter) is usually 100 μm or more, but from the viewpoint of increasing the capacity of the non-aqueous electrolyte secondary battery, it is preferably 200 μm or more. In general, the output characteristics of a non-aqueous electrolyte secondary battery can be improved by making the positive electrode and negative electrode thinner, but according to the present invention, it is possible to improve the output characteristics even when the molded body of the electrode composition is as thick as 200 μm or more. In particular, when the electrode is a positive electrode, the effect of an increase of the resistance of the positive electrode due to decomposition of the solid electrolyte occurring inside the positive electrode is small, so that good output characteristics can be ensured even if the thickness of the molded body of the electrode composition (the molded body of the positive electrode composition) is made as thick as 200 μm or more. Therefore, in the present invention, when the thickness of the molded body of the electrode composition is, for example, 200 μm or more, the effect becomes more remarkable. Also, the thickness of the molded body of the electrode composition is usually 3,000 μm or less.

In the case where the electrode is produced by forming an electrode composition layer on a current collector using an electrode composition mixture, which contains a solvent, the thickness of the molded body of the electrode composition layer is preferably 100 to 1000 μm.

### <Non-Aqueous Electrolyte Secondary Battery>

The non-aqueous electrolyte secondary battery of the present invention comprises a positive electrode, a negative electrode, and a separator or a solid electrolyte layer interposed between the positive electrode and the negative electrode, and at least one of the positive electrode and the negative electrode is an electrode for the non-aqueous electrolyte secondary battery of the present invention. As for the configuration other than the electrodes, various configurations employed in conventionally known non-aqueous electrolyte secondary batteries can be applied.

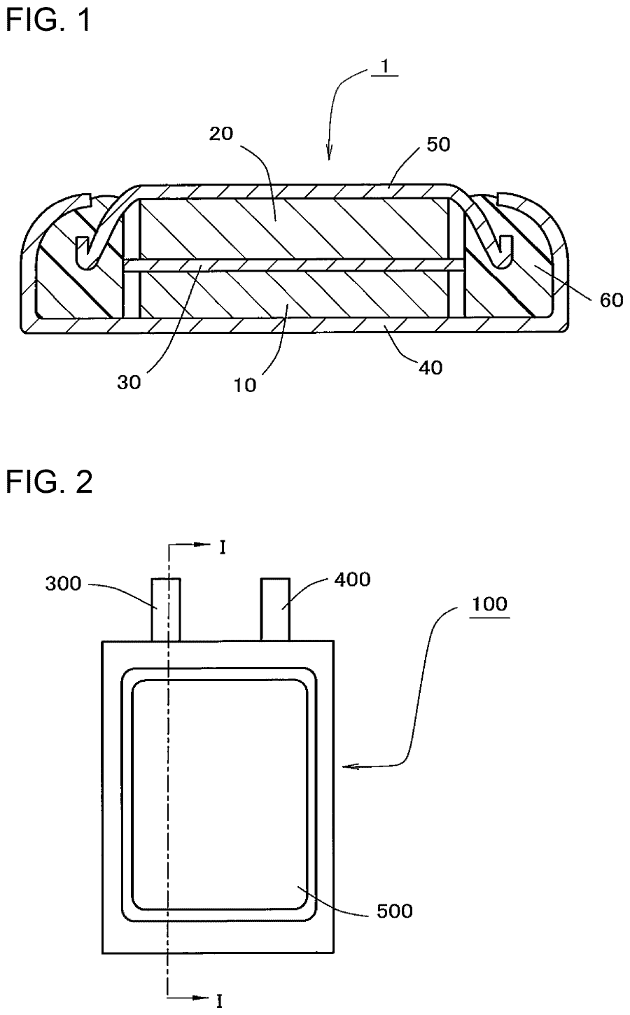

FIG. 1 is a cross-sectional view schematically showing an embodiment of a non-aqueous electrolyte secondary battery of the present invention. The non-aqueous electrolyte secondary battery 1 shown in FIG. 1 has a positive electrode 10, a negative electrode 20, a separator (a solid electrolyte layer in the case of an all-solid-state secondary battery) 30 interposed between the positive electrode 10 and the negative electrode 20, and a non-aqueous electrolyte (in the case of a non-aqueous electrolyte secondary battery other than all-solid-state secondary battery) housed in an exterior body formed of an exterior can 40, a sealing can 50, and a resin gasket 60 interposed between them.

The sealing can 50 is fitted into the opening of the exterior can 40 via a gasket 60, and the open end of the exterior can 40 is tightened inward, thereby the gasket 60 coming into contact with the sealing can 50, thereby sealing the opening of the exterior can 40 to form an airtight structure inside the battery.

The exterior can and the sealing can be made of stainless steel or the like. In addition, polypropylene, nylon, etc. can be used as the material for the gasket. In addition, in cases where heat resistance is required in relation to the use of the battery, heat-resistant resins with melting points exceeding 240° C. can also be used, which include: fluororesins such as tetrafluoroethylene-perfluoroalkoxyethylene copolymer (PFA); polyphenylene ether (PPE); polysulfone (PSF); polyarylate (PAR); polyethersulfone (PES); polyphenylene sulfide (PPS); and polyetheretherketone (PEEK). Furthermore, when the battery is used in an application requiring heat resistance, a glass hermetic seal can be used for sealing the battery.

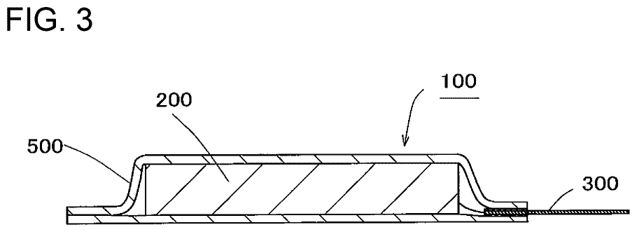

Also, FIGS. 2 and 3 are drawings schematically showing another embodiment of the non-aqueous electrolyte secondary battery of the present invention. FIG. 2 is a plan view of the non-aqueous electrolyte secondary battery, and FIG. 3 is a cross-sectional view taken along line I-I of FIG. 2.

The non-aqueous electrolyte secondary battery 100 shown in FIGS. 2 and 3 houses an electrode body 200 in a laminate film exterior body 500 made of two metal laminate films, and the laminate film exterior body 500 is sealed at its outer periphery by heat fusing the upper and lower metal laminate films.

When the non-aqueous electrolyte secondary battery 100 is an all-solid-state secondary battery, the electrode body 200 is configured by laminating a positive electrode, a negative electrode, and a solid electrolyte layer interposed between them. On the other hand, when the non-aqueous electrolyte secondary battery 100 is a non-aqueous electrolyte secondary battery other than all-solid-state secondary batteries, the electrode body 200 is configured by laminating a positive electrode, a negative electrode, and a separator interposed between them, and a non-aqueous electrolyte is enclosed in the laminate film exterior body 500 together with this electrode body 200.

In addition, in FIG. 3, in order to avoid complicating the drawing, the layers that make up the laminate film exterior body 500 and the components (positive electrode, negative electrode, etc.) that constitute the electrode body 200 are not distinguishably shown.

The positive electrode of the electrode body 200 is connected to a positive electrode external terminal 300 within the battery 100, and although not shown, the negative electrode of the electrode body 200 is also connected to a negative electrode external terminal 400 within the battery 100. One end of each of the positive electrode external terminal 300 and the negative electrode external terminal 400 is extended outside the laminate film exterior body 500 so as to be able to connect to an external device or the like.

### (Positive Electrode)

The electrode of the present invention can be used for the positive electrode of a non-aqueous electrolyte secondary battery, but if the negative electrode is the electrode of the present invention, a positive electrode other than the electrode of the present invention can also be used. Examples of the positive electrodes other than the electrode of the present invention include a positive electrode having the same configuration as the electrode of the present invention except that D₂ and D₃ do not satisfy the above relationship, and a positive electrode having the same configuration as the electrode of the present invention except that L and D do not satisfy the above relationship.

### (Negative Electrode)

The electrode of the present invention can be used for the negative electrode of a non-aqueous electrolyte secondary battery, but if the positive electrode is the electrode of the present invention, a negative electrode other than the electrode of the present invention can also be used. Examples of the negative electrodes other than the electrode of the present invention include negative electrodes having the same configuration as the electrode of the present invention except that D₂ and D₃ do not satisfy the above-mentioned relationship, a negative electrodes having the same configuration as the electrode of the present invention except that L and D₂ do not satisfy the above-mentioned relationship, and a negative electrode having a lithium sheet or a lithium alloy sheet.

In the case of a negative electrode other than the electrode of the present invention, which has a molded body of a negative electrode composition, the content of the solid electrolyte can be 0 to 85 mass %.

In the case of a negative electrode having a lithium sheet or a lithium alloy sheet, one consisting of such a sheet or one consisting of such a sheet laminated with a current collector is used.

Examples of alloying elements for lithium alloys include aluminum, lead, bismuth, indium, and gallium, but aluminum and indium are preferred. The proportion of alloying elements in the lithium alloy (the total proportion of the alloying elements when multiple types of alloying elements are included) is preferably 50 atomic % or less (in this case, the balance is lithium and inevitable impurities).

In the case of a negative electrode having a lithium alloy sheet, a laminate is used in which a layer containing an alloying element which can form a lithium alloy is laminated on the surface of a lithium layer (a layer containing lithium) made of metallic lithium foil or the like, for example by pressure bonding. Then the laminate is brought into contact with a solid electrolyte or a non-aqueous electrolyte in a battery, to form a lithium alloy on the surface of the lithium layer, thereby forming a negative electrode. In the case of such a negative electrode, a laminate including a layer containing an alloying element formed on only one side of the lithium layer can be used, or a laminate including layers containing an alloying element formed on both sides of the lithium layer can be used. The laminate can be formed, for example, by pressure bonding a metallic lithium foil and a foil composed of an alloy element.

The current collector can also be used when a lithium alloy is formed within a battery to serve as a negative electrode. For example, a laminate including a lithium layer formed on one side of a negative electrode current collector and a layer containing an alloying element formed on the side of the lithium layer opposite the negative electrode current collector can be used, or a laminate including lithium layers formed on both sides of a negative electrode current collector and a layer containing an alloying element formed on the side of each lithium layer opposite the negative electrode current collector can be used. The negative electrode current collector and the lithium layer (metallic lithium foil) can be laminated by compression bonding or the like.

For the layer containing the alloying elements in the laminate to be used as the negative electrode, for example, a foil composed of these alloying elements can be used. The thickness of the layer containing the alloying element is preferably 1 μm or more, more preferably 3 μm or more, and is preferably 20 μm or less, more preferably 12 μm or less.

For the lithium layer of the laminate to be used as the negative electrode, for example, metallic lithium foil can be used. The thickness of the lithium layer is preferably 0.1 to 1.5 mm. In addition, in the case of a negative electrode having a sheet of lithium or a lithium alloy, the thickness of the sheet is preferably 0.1 to 1.5 mm.

In addition, when a negative electrode having a lithium sheet or a lithium alloy sheet has a current collector, the current collector can be the same as the current collectors exemplified above as those usable when the electrode of the present invention is a negative electrode.

### (Solid Electrolyte Layer)

When the non-aqueous electrolyte secondary battery is an all-solid-state secondary battery, the solid electrolyte in the solid electrolyte layer interposed between the positive electrode and the negative electrode can be of one or more of the various sulfide-based solid electrolytes, hydride-based solid electrolytes, halide-based solid electrolytes, and oxide-based solid electrolytes exemplified above as usable for the electrodes. However, in order to improve the battery characteristics, it is preferable to contain a sulfide-based solid electrolyte, and it is more preferable to contain an argyrodite type sulfide-based solid electrolyte. It is more preferable that all of the positive electrode, the negative electrode and the solid electrolyte layer contain a sulfide-based solid electrolyte, and it is even more preferable that they contain an argyrodite type sulfide-based solid electrolyte.

The solid electrolyte layer can be provided with a porous body such as a resin nonwoven fabric as a support.

The solid electrolyte layer can be formed by: e.g., a method of compressing a solid electrolyte by pressure molding; and a method of applying a composition for forming a solid electrolyte layer, which is prepared by dispersing a solid electrolyte in a solvent, onto a substrate (including a porous body serving as a support), a positive electrode, or a negative electrode, followed by drying the composition, and, if necessary, performing pressure molding such as pressing.

As a solvent used in the composition for forming a solid electrolyte layer, it is desirable to select such a solvent that is unlikely to deteriorate the solid electrolyte. It is preferable to use the same solvent as the various solvents exemplified above as the solvent for the electrode composition mixture.

The thickness of the solid electrolyte layer is preferably 10 to 500 μm.

### (Separator)

If the non-aqueous electrolyte secondary battery is a battery other than an all-solid-state secondary battery, the separator interposed between the positive electrode and the negative electrode should have sufficient strength and be able to retain a large amount of non-aqueous electrolyte. From the viewpoint of this, it is preferable to use a microporous film or nonwoven fabric containing polyethylene, polypropylene, or ethylene-propylene copolymer with a thickness of 10 to 50 μm and an opening ratio of 30 to 70%.

### (Non-Aqueous Electrolyte)

If the non-aqueous electrolyte secondary battery is a battery other than an all-solid-state secondary battery, a non-aqueous electrolyte is used, which is usually a non-aqueous liquid electrolyte (hereinafter referred to as “electrolyte solution”). The electrolyte used is an organic solvent in which an electrolyte salt such as a lithium salt is dissolved. The organic solvent is not particularly limited. For example, the examples thereof can include chain esters such as dimethyl carbonate, diethyl carbonate, ethyl methyl carbonate, and methyl propyl carbonate; cyclic esters with high dielectric constants such as ethylene carbonate, propylene carbonate, butylene carbonate, and vinylene carbonate: mixed solvents of the chain esters and the cyclic esters; and etc. In particular, the mixed solvents of the cyclic esters and the chain esters as the main solvent are suitable.

Examples of electrolyte salts to be dissolved in an organic solvent in preparing the electrolyte solution can include LiPF₆, LiBF₄, LiAsF₆, LiSbF₆, LiCF₃SO₃, LiC₄F₉SO₃, LiCF₃CO₂, Li₂C₂F₄(SO₃)₂, LiCₙF₂ₙ₊₁SO₃(n≥₂), LiN(RfSO₂)(Rf′SO₂). LiC(RfSO₂)₃, and LiN(RfOSO₂)₂ (wherein Rf and Rf′ are fluoroalkyl groups) can be used alone or in combination of two or more. The concentration of the electrolyte salt in the electrolyte solution is not particularly limited, but is preferably 0.3 mol/L or more, more preferably 0.4 mol/L or more, and is preferably 1.7 mol/L or less, more preferably 1.5 mol/L or less.

In the non-aqueous electrolyte secondary battery of the present invention, in addition to the above-mentioned electrolytic solution, a gel electrolyte obtained by gelling the above-mentioned electrolytic solution with a gelling agent made of a polymer or the like can also be used as the non-aqueous electrolyte.

### (Electrode Body)

The positive and negative electrodes can be used in a battery in the form of a laminated electrode body in which they are laminated with a solid electrolyte layer or a separator between them, or in the form of a wound electrode body in which the laminated electrode body is wound.

When forming an electrode body having a solid electrolyte layer, it is preferable to do a pressure molding of the positive electrode, negative electrode, and solid electrolyte layer in a laminated state from the viewpoint of increasing the mechanical strength of the electrode body.

### (Battery Configuration)

The configuration of the non-aqueous electrolyte secondary battery can be one having an exterior body composed of an exterior can, a sealing can, and a gasket as shown in FIG. 1, i.e., one generally known as a coin-type battery or button-type battery; or one having an exterior body composed of a resin film or a metal-resin laminate film as shown in FIGS. 2 and 3; or one having an exterior body made of a metal, bottomed, tubular (cylindrical or rectangular) exterior can having a sealing structure that seals the opening.

### EXAMPLES

The present invention will be described in detail below with reference to the Examples. However, it is noted that the following examples should not be used to narrowly construe the scope of the present invention.

### Example 1

### <Preparation of the Positive Electrode>

0.86 g of lithium and 38.7 g of pentaethoxyniobium were mixed in 394 g of dehydrated ethanol to prepare a coating solution for forming a reaction suppression layer. Next, the coating solution for forming the reaction suppression layer was applied onto 1000 g of a positive electrode active material (LiCoO₂) at a rate of 2 g per minute using a coating device using a tumbling fluidized bed. The obtained powder was treated with heat at 350° C. to obtain a positive electrode material having a reaction suppression layer formed on the surface thereof, the reaction suppression layer being composed of 2 parts by mass of LiNbO₃ per 100 parts by mass of the positive electrode active material.

The positive electrode material, vapor-grown carbon fiber (conductive assistant) and Li₆PS₅Cl (sulfide-based solid electrolyte) were mixed together to prepare a positive electrode composition. The mixture ratio of the positive electrode material, the conductive assistant, and the sulfide-based solid electrolyte was 66:4:30 in terms of mass ratio. 117 mg of the positive electrode composition above was placed in a powder molding die having a diameter of 7.5 mm, and molding was performed using a press at a pressure of 1000 kgf/cm² to produce a positive electrode made of a cylindrical molded body of the positive electrode composition.

### <Formation of Solid Electrolyte Layer>

17 mg of the same sulfide-based solid electrolyte used for the positive electrode was put on the molded body of the positive electrode composition in the powder molding die, and molding was performed using a press at a pressure of 1000 kgf/cm² to form a solid electrolyte layer on the molded body of the positive electrode composition.

### <Formation of the Negative Electrode and Preparation of the Laminated Electrode Body>

Active materials were synthesized using a solid-state reaction method with various metal oxide powders (all obtained from Kojundo Chemical Co., Ltd.) as starting materials. Nb₂O₅ with an average particle size of 1 μm (purity: >99.9%), α-Al₂O₃ with an average particle size of 1 μm (purity: >99.99%), and CuO (purity: >99.99%) were weighed out in amounts of 96.72 g, 2.34 g, and 1.04 g, respectively, and then mixed together. The mixture of starting materials was added to a zirconia container with a capacity of 500 ml together with 70 g of ethanol and 300 g of YSZ balls with a diameter of 5 mm, and mixed for 3 hours at 250 rpm in a planetary ball mill (“Planetary Mill Pulverisette 5″ (product name) manufactured by Fritsch Corporation), followed by separating the zirconia balls from the sample after the mixing process to obtain a slurry, which was then dried to obtain a precursor powder of the negative electrode active material. The precursor powder was transferred to an alumina crucible, and the temperature was raised to 1000° C. at a rate of 16° C./min in an air atmosphere, and then the mixture was kept for 4 hours for firing, and then naturally cooled to room temperature. The powder as obtained was crushed in a mortar for 5 minutes and passed through a sieve with 150 μm openings to obtain a crude active material. 4 g of the crude active material was added to a zirconia vessel having an internal volume of 12.5 ml together with 4 g of ethanol and 30 g of YSZ balls having a diameter of 5 mm, and was subjected to a crushing treatment in the planetary ball mill at 250 rpm for 3 hours. The obtained slurry was dried under reduced pressure at 60° C. overnight to obtain particles of Cu_{0.2}Al_{0.74}Nb_{11.05}O_{27.89} as the negative electrode active material.

The powder XRD pattern of the obtained negative electrode active material was measured, and it was confirmed that the negative electrode active material had a monoclinic crystal structure and which is in the C2/m space group.

The negative electrode active material particles, graphene (particles of conductive assistant), and a sulfide-based solid electrolyte (Li₆PS₅Cl) were mixed in a mass ratio of 69:5.5:25.5, and kneaded in an automatic mortar (“Motor Grinder P-2” (product name) manufactured by Fritsch Corporation) for 1 hour in an argon atmosphere to prepare a negative electrode composition. Next, 57 mg of the negative electrode composition was poured onto the solid electrolyte layer in the powder molding die, and molding was performed using a press at a pressure of 10,000 kgf/cm² to form a negative electrode composed of the molded body of the negative electrode composition on the solid electrolyte layer, thereby obtaining a laminated electrode body in which the positive electrode, the solid electrolyte layer and the negative electrode were laminated. The particles of the negative electrode active material contained in the obtained negative electrode (the molded body of the negative electrode composition) had a volume-based particle size distribution in which volume fractions of the small particle and of large particle were 14 vol % and 86 vol %, respectively. D₁ was 0.36 μm and D₂ was 0.80 μm. Moreover, the particles of the conductive assistant contained in the negative electrode (the molded body of the negative electrode composition) had D₃ of 0.30 μm and L of 0.68 μm.

<Assembly of all-Solid-State Secondary Battery>

Two sheets of flexible graphite sheet “PERMA-FOLL (product name)” manufactured by Toyo Tanso Co., Ltd. (thickness: 0.1 mm, apparent density: 1.1 g/cm³) were punched out to be the same size as the laminated electrode body, and one of them was placed on the inner bottom surface of a stainless steel sealed can fitted with a polypropylene ring gasket. Next, the laminated electrode body was placed on the graphite sheet, with the negative electrode facing the graphite sheet side, onto which another graphite sheet was placed. Then, a stainless steel exterior can was placed, followed by that the open end of the exterior can was crimped inward to seal it, thereby producing a flat all-solid-state secondary battery having a diameter of approximately 9 mm, in which the graphite sheets were placed between the inner bottom surface of the sealing can and the laminated electrode body, and between the inner bottom surface of the exterior can and the laminated electrode body.

### Example 2

A laminated electrode body was fabricated by forming a negative electrode in the same manner as in Example 1, except that the mixing time of the starting materials of the negative electrode active material was changed to 6 hours. The particles of the negative electrode active material contained in the obtained negative electrode (the molded body of the negative electrode composition) had a volume-based particle size distribution in which volume fractions of the small particle and of large particle were 10 vol % and 90 vol %, respectively. Dt was 0.31 Ian and D₂ was 0.73 μm. Moreover, the particles of the conductive assistant contained in the negative electrode (the molded body of the negative electrode composition) had D₃ of 0.20 μm and L of 0.60 μm. Then, an all-solid-state secondary battery was fabricated in the same manner as in Example 1, except for using the laminated electrode body above.

### Comparative Example 1

A laminated electrode body was fabricated by forming a negative electrode in the same manner as in Example 1, except that the mixing time of the negative electrode composition was changed to 5 minutes. The particles of the negative electrode active material contained in the obtained negative electrode (the molded body of the negative electrode composition) had a volume-based particle size distribution in which volume fractions of the small particle and of large particle were 12 vol % and 88 vol %, respectively. D₁ was 0.30 μm and D₂ was 0.69 μm. Moreover, the particles of the conductive assistant contained in the negative electrode (the molded body of the negative electrode composition) had D₃ of 4.20 μm and L of 0.82 μm. Then, an all-solid-state secondary battery was fabricated in the same manner as in Example 1, except for using the laminated electrode body above.

The all-solid-state secondary batteries of Examples 1 and 2 and Comparative Example 1 were evaluated as follows.

### <Discharge Capacity Measurement>

The all-solid-state secondary batteries of Examples 1 and 2 and Comparative Example 1 were charged at a constant current of 0.05 C until the voltage reached 3.5 V, then charged at a constant voltage until the current reached 0.005 C, and then discharged at a constant current of 0.05 C until the voltage reached 1.0 V, and then the discharge capacity (initial capacity) was measured.

### <Direct Current Resistance (DCR) Measurement>

After measuring the discharge capacity, each all-solid-state secondary battery was charged at a constant current and a constant voltage under the same conditions as when measuring the discharge capacity, and the open-end potential was measured for 1 hour. After that, the battery was discharged at a constant current of 0.05 C. The voltage difference between the open-end voltage and the voltage one second after the start of discharge was subtracted by the voltage drop attributable to the solid electrolyte layer and the counter electrode, from which a DCR was calculated. The smaller the DCR value, the better the output characteristics of the battery.

The physical properties of the particles of the negative electrode active material contained in the negative electrodes used in the all-solid-state secondary batteries of Examples 1 and 2 and Comparative Example 1, and the values of D₃ and L related to the particles of the conductive assistant are shown in Table 1, and the evaluation results are shown in Table 2. The evaluation results shown in Table 2 are expressed as relative values with the value of Comparative Example 1 being assumed 100.

TABLE 1

| | Volume fraction (vol. %) | | | | | |
|---|---|---|---|---|---|---|
| | Small | Large | D₁ | D₂ | D₃ | L |
| | particles | particles | (μm) | (μm) | (μm) | (μm) |
| Ex. 1 | 14 | 86 | 0.36 | 0.80 | 0.30 | 0.68 |
| Ex. 2 | 10 | 90 | 0.31 | 0.73 | 0.20 | 0.60 |
| Comp. Ex. 1 | 12 | 88 | 0.30 | 0.69 | 4.20 | 0.82 |

TABLE 2

| | DCR | Discharge capacity |
|---|---|---|
| Ex. 1 | 31 | 122 |
| Ex. 2 | 27 | 128 |
| Comp. Ex. 1 | 100 | 100 |

As shown in Tables 1 and 2, the all-solid-state secondary batteries of Examples 1 and 2 had small DCR, excellent output characteristics, and large discharge capacity, since each of them used the negative electrode in which the particles of the negative electrode active material have an appropriate particle size distribution in the molded body of the negative electrode composition, and which satisfied an appropriate relationships regarding D₂ of the particles of the negative electrode active material, and D₃ and L of the particles of the conductive assistant.

By contrast, the battery of Comparative Example 1 had a large DCR, poor output characteristics, and a small discharge capacity, since it used the negative electrode which had inappropriate relationships regarding D₂ of the negative electrode active material particles, and D₃ and L of the conductive assistant particles in the molded body of the negative electrode composition.

### Example 3

### <Preparation of the Positive Electrode>

10.62 g of Li₂CO₃, and 50.75 g of NiMn composite compound synthesized by coprecipitation method were mixed with air using a vibration mill to obtain a precursor for a spinel type positive electrode active material. This precursor was heated from room temperature to 1000° C. at 11° C./min, fired at 1000° C. for 1 hour, cooled from 1000° C. to 850° C. at 1.7° C./min, fired at 850° C. for 12 hours, cooled from 850° C.: to 550° C. at 3.0° C./min, fired at 550° C. for 12 hours, cooled from 550° C. to 200° C. at 3.0° C./min, naturally cooled from 200° C. to room temperature, and then crushed in a mortar to obtain particles of a spinel type positive electrode active material (LNi_{0.5}Mn_{1.5}O₄).

The spinel type positive electrode active material particles, vapor grown carbon fibers (particles of conductive assistant), and Li₆PS₅Cl (sulfide-based solid electrolyte) were mixed in the automatic mortar for 1 hour to prepare a positive electrode mixture. The mixing ratio of the spinel type positive electrode active material particles, the conductive assistant particles, and the sulfide-based solid electrolyte was 75:3:22 by mass. 56 mg of the positive electrode composition above was placed in a powder molding die having a diameter of 7.5 mm, and molding was performed using a press at a pressure of 1000 kgf/cm² to produce a positive electrode made of a cylindrical molded body of the positive electrode composition. The particles of the spinel-type positive electrode active material contained in the obtained positive electrode (the molded body of the positive electrode composition) had a volume-based particle size distribution in which volume fractions of the small particle and of the large particle were 39 vol % and 61 vol %, respectively. D₁ was 5.3 μm, and D₂ was 8.5 μm. The proportion of Mn³⁺ in the total Mn was 4.0%, and I₍₁₁₀₎/I₍₂₂₀₎ was 0. Moreover, the particles of the conductive assistant contained in the positive electrode (the molded body of the positive electrode composition) had D₃ of 2.4 μm and L of 0.5 μm.

### <Formation of Solid Electrolyte Layer>

17 mg of the same sulfide-based solid electrolyte used for the positive electrode was put on the molded body of the positive electrode composition in the powder molding die, and molding was performed using a press at a pressure of 1000 kgf/cm² to form a solid electrolyte layer on the molded body of the positive electrode composition.

### <Formation of the Negative Electrode and Preparation of the Laminated Electrode Body>

Lithium titanate (Li₄Ti₅O₁₂, negative electrode active material), the same sulfide solid electrolyte as used in the solid electrolyte layer, and graphene (conductive assistant) were mixed in a mass ratio of 55:36:9 and thoroughly kneaded to prepare a negative electrode composition. Next, 93 mg of the negative electrode composition was poured onto the solid electrolyte layer in the powder molding die, and molding was performed using a press at a pressure of 10,000 kgf % cm² to form a negative electrode composed of the molded body of the negative electrode composition on the solid electrolyte layer, thereby obtaining a laminated electrode body in which the positive electrode, the solid electrolyte layer and the negative electrode were laminated.

<Assembly of all-Solid-State Secondary Battery>

A flat all-solid-state secondary battery with a diameter of approximately 9 mm was fabricated in the same manner as in Example 1, except that the laminated electrode body was used.

### Example 4

A positive electrode was prepared in the same manner as in Example 3, except that a part of the firing conditions for the spinel-type positive electrode active material were changed to lower the temperature from 850° C. to 600° C. at 1.4° C./min, fired at 600° C. for 12 hours, and then lowered the temperature from 600° C. to 200° C. at 2.2° C./min. The particles of the spinel-type positive electrode active material contained in the obtained positive electrode (the molded body of the positive electrode composition) had a volume-based particle size distribution in which volume fractions of the small particle and of the large particle were 39 vol % and 61 vol %, respectively. D₁ was 5.3 μm, and D₂ was 8.5 μm. The proportion of Mn³ in the total Mn was 3.4%, and I₍₁₁₀)/I₍₂₂₀₎ was 0. Moreover, the particles of the conductive assistant contained in the positive electrode (the molded body of the positive electrode composition) had a D₃ of 2.4 am and an L of 0.5 μm. Then, an all-solid-state secondary battery was produced in the same manner as in Example 3, except that the positive electrode above was used.

### Example 5

10.62 g of Li₂CO₃, 50.75 g of NiMn composite compound synthesized by coprecipitation method, and 0.23 g of MgO were mixed with air using a vibration mill to prepare a precursor for a spinel type positive electrode active material. Except for using this precursor, particles of a spinel type positive electrode active material (LiMg_{0.05}Ni_{0.5}Mn_{1.5}O₄) were produced in the same manner as in Example 3. The spinel-type positive electrode active material contained in the obtained positive electrode had a volume-based particle size distribution in which volume fractions of the small particle and of the large particle were 39 vol % and 61 vol %, respectively. D₁ was 5.3 μm, and D₂ was 8.5 μm. The proportion of Mn³⁺ in the total Mn was 3.5%, and I₍₁₁₀₎/I₍₂₂₀₎ was 0. Moreover, the particles of the conductive assistant contained in the positive electrode (the molded body of the positive electrode composition) had D₃ of 2.4 μm and L of 0.5 μm. Then, an all-solid-state secondary battery was produced in the same manner as in Example 3, except that the positive electrode above was used.

### Example 6

The firing conditions were changed to heating from room temperature to 1000° C. at 11° C./min, firing at 1000° C. for 1 hour, lowering the temperature from 1000° C. to 850° C. at 1.7° C./min, firing at 850° C. for 12 hours, and naturally cooling from 850° C. to room temperature. Except for this, particles of spinel-type positive electrode active material were produced in the same manner as in Example 3, and an all-solid-state secondary battery was produced in the same manner as in Example 3. The particles of the spinel-type positive electrode active material contained in the positive electrode (the molded body of the positive electrode composition) used in the all-solid-state secondary battery of Example 6 had a volume-based particle size distribution in which volume fractions of the small particle and of the large particle were 39 vol % and 61 vol %, respectively. D₁ was 5.3 μm, and D₂ was 8.5 pn. The proportion of Mn³ in the total Mn was 8.0%, and I₍₁₁₀₎/I₍₂₂₀₎ was 0. Moreover, the particles of the conductive assistant contained in the positive electrode (the molded body of the positive electrode composition) had D₃ of 2.4 μm and L of 0.5 μm.

### Example 7

The firing conditions were changed to the following: heating from room temperature to 1000° C. at 11° C./min, firing at 1000° C. for 1 hour, cooling from 1000° C. to 850° C. at 1.7° C./min, firing at 850° C. for 12 hours, cooling from 850° C. to 700° C. at 1.7° C./min, firing at 700° C. for 12 hours, cooling from 700° C. to 600° C. at 1.1° C./min, firing at 600° C. for 12 hours, cooling from 600° C. to 200° C. at 2.2° C./min, and then cooling naturally from 200° C. to room temperature. Except for these changes of the firing conditions, particles of spinel-type positive electrode active material were produced in the same manner as in Example 3, and except for using it, an all-solid-state secondary battery was produced in the same manner as in Example 3. The particles of the spinel-type positive electrode active material contained in the positive electrode (the molded body of the positive electrode composition) used in the all-solid-state secondary battery of Example 7 had a volume-based particle size distribution in which volume fractions of the small particle and of the large particle were 39 vol % and 61 vol %, respectively. D₁ was 5.3 μm, and D₂ was 8.5 μm, the proportion of Mn³ in the total Mn was 2.9%, and I₍₁₁₀₎/I₍₂₂₀₎ was 1.3. Moreover, the particles of the conductive assistant contained in the positive electrode (the molded body of the positive electrode composition) had D₃ of 2.4 μm and L of 0.5 μm.

### Comparative Example 2

10.62 g of Li₂CO₃, 50.75 g of NiMn composite compound synthesized by coprecipitation method, 50 cc of zirconia balls with a diameter of 5 mm, and 50 cc of ethanol were placed in a zirconia pot, and wet-mixed for 3 hours at 250 rpm using a planetary ball mill to minimize air inclusion. The crushing process after firing was changed to a method in which 50 cc of zirconia balls with a diameter of 5 mm. 50 cc of ethanol, and the fired spinel-type positive electrode active material were placed in a zirconia pot, and wet-crushed for 3 hours using a planetary ball mill at 250 rpm. Except for making the changes identified above, particles of spinel-type positive electrode active material were prepared in the same manner as in Example 3, and an all-solid-state secondary battery was prepared in the same manner as in Example 3, The particles of the spinel-type positive electrode active material contained in the positive electrode (the molded body of the positive electrode composition) used in the all-solid-state secondary battery of Comparative Example 2 had a volume-based particle size distribution in which volume fractions of the small particle and of the large particle were 72 vol % and 28 vol %, respectively. D₁ was 2.4 μm, and D₂ was 7.9 μm. The proportion of Mn₃₊ in the total Mn was 4.2%, and I₍₁₁₀₎/I₍₂₂₀₎ was 0. Moreover, the particles of the conductive assistant contained in the positive electrode (the molded body of the positive electrode composition) had D₃ of 2.4 μm and L of 0.5 μm.

### Comparative Example 3

A spinel-type positive electrode active material was produced in the same manner as in Example 3, except that the crushing process after firing was changed to a method in which 50 cc of zirconia balls with a diameter of 5 mm, 50 cc of ethanol, and the spinel-type positive electrode active material were placed in a zirconia pot and wet-crushed for 3 hours at 250 rpm using a planetary ball mill. An all-solid-state secondary battery was produced in the same manner as in Example 1, except for using the spinel-type positive electrode active material. The spinel-type positive electrode active material contained in the positive electrode used in the all-solid-state secondary battery of Comparative Example 3 had a volume-based particle size distribution in which volume fractions of the small particle and of the large particle were 72 vol % and 28 vol %, respectively. D₁ was 2.4 μm, and D₂ was 7.9 μm, the proportion of Mn³ in the total Mn was 4.0%, and I₍₁₁₀₎/I₍₂₂₀₎ was 0. Moreover, the particles of the conductive assistant contained in the positive electrode (the molded body of the positive electrode composition) had D₃ of 2.4 μm and L of 0.5 μm.

For the all-solid-state secondary batteries of Examples 3 to 7 and Comparative Examples 2 and 3, charge and discharge tests were performed in the same manner as for the batteries of Examples 1 and 2 and Comparative Example 1, to measure the discharge capacity (initial capacity) and to measure the DCR, except that the lower limit of the constant current discharge voltage was changed to 1.5 V.

The physical properties of the particles of the positive electrode active material contained in the positive electrodes used in the all-solid-state secondary batteries of Examples 3 to 7 and Comparative Examples 2 and 3, and the values of D₃ and L related to the particles of the conductive assistant are shown in Table 3, and the evaluation results are shown in Table 4. The evaluation results shown in Table 4 are expressed as relative values with the value of Comparative Example 2 being assumed 100.

TABLE 3

| | Volume fraction (vol. %) | | | | | | Mn³⁺ | |
|---|---|---|---|---|---|---|---|---|
| | Small | Large | D₁ | D₂ | D₃ | L | proportion in | I₍₁₁₀₎/ |
| | particles | particles | (μm) | (μm) | (μm) | (μm) | total Mn (%) | I₍₂₂₀₎ |
| Ex. 3 | 39 | 61 | 5.3 | 8.5 | 2.4 | 0.5 | 4.0 | 0 |
| Ex. 4 | 39 | 61 | 5.3 | 8.5 | 2.4 | 0.5 | 3.4 | 0 |
| Ex. 5 | 39 | 61 | 5.3 | 8.5 | 2.4 | 0.5 | 3.5 | 0 |
| Ex. 6 | 39 | 61 | 5.3 | 8.5 | 2.4 | 0.5 | 8.0 | 0 |
| Ex. 7 | 39 | 61 | 5.3 | 8.5 | 2.4 | 0.5 | 2.9 | 1.3 |
| Comp. | 72 | 28 | 2.4 | 7.9 | 2.4 | 0.5 | 4.2 | 0 |
| Ex. 2 | | | | | | | | |
| Comp. | 72 | 28 | 2.4 | 7.9 | 2.4 | 0.5 | 4.0 | 0 |
| Ex. 3 | | | | | | | | |

TABLE 4

| | DCR | Discharge capacity |
|---|---|---|
| Ex. 3 | 57 | 284 |
| Ex. 4 | 53 | 285 |
| Ex. 5 | 45 | 296 |
| Ex. 6 | 89 | 224 |
| Ex. 7 | 60 | 184 |
| Comp. Ex. 2 | 100 | 100 |
| Comp. Ex. 3 | 103 | 111 |

As shown in Tables 3 and 4, the all-solid-state secondary batteries of Examples 3 to 7 had small DCR, excellent output characteristics, and large discharge capacity, because they used the positive electrodes in which the D₂ of the spinel-type positive electrode active material particles, and the D₃ and the L of the conductive assistant particles in the molded body of the electrode composition satisfy an appropriate relationship.

By contrast, the batteries of Comparative Examples 2 and 3 had large DCR, poor output characteristics, and small discharge capacity, as they used positive electrodes in which the particle size of the spinel-type positive electrode active material in the molded body of the positive electrode composition was inappropriate.

There can be provided other embodiments than the description above without departing the gist of the present invention. The embodiment described above is an example only, and the present invention is not limited to the specific embodiment. The scope of the present invention should be construed primarily based on the claims, not to the description of the specification or the present application. Any changes within the terms of the claims and the equivalence thereof should be construed as falling within the scope of the claims.

### INDUSTRIAL APPLICABILITY

The non-aqueous electrolyte secondary battery of the present invention has excellent output characteristics and can be preferably used in applications requiring such characteristics. In addition, the battery can also be applied to other applications in which conventionally known non-aqueous electrolyte secondary batteries have been used.

### EXPLANATION OF THE REFERENCE

1, 100 Non-aqueous electrolyte secondary battery
10 Positive electrode
20 Negative electrode
30 Solid electrolyte layer or separator
40 Exterior can
50 Sealing can
60 Gasket
200 Electrode body
300 Positive electrode external terminal
400 Negative electrode external terminal
500 Laminate film exterior body

1. An electrode for a non-aqueous electrolyte secondary battery having a molded body of an electrode composition comprising at least particles of an electrode active material, a solid electrolyte, and particles of a conductive assistant,
wherein the particles of an electrode active material has a volume-based particle size distribution comprising: a small particle distribution of small particles having a diameter of maximum frequency D₁ (μM), and a large particle distribution of large particles having a diameter of maximum frequency D₂ (μm), in which the volume-based particle size distribution is determined by observing a cross section of the molded body of the electrode composition,
wherein when an entire volume of the particles of the electrode active material is assumed to be 100%, a volume fraction of the large particles is larger than a volume fraction of the small particles,
wherein D₃≤D₂ is satisfied, in which D₃ (μm) is a mode diameter of the particles of the conductive assistant in the volume-based particle size distribution,
wherein L≤D₂ is satisfied, in which L is an arithmetic average value of an inter-distance of gravity center L_{d} which is an arithmetic average value of L₁, L₂ and L₃, in which
L₁ is an Euclidean distance between a gravity center of a first particle of the conductive assistant, and a gravity center of a second particle of the conductive assistant particle closest to the first particle, the first particle is arbitrarily obtained by observing the cross section,
L₂ is an Euclidean distance between the gravity center of the first particle of the conductive assistant, and a gravity center of a third particle of the conductive assistant particle second closest to the first particle;
L₃ is an Euclidean distance between the gravity center of the first particle of the conductive assistant, and a gravity center of a fourth particle of the conductive assistant particle third closest to the first particle.

2. The electrode for the non-aqueous electrolyte secondary battery according to claim 1, wherein the electrode active material is a spinel type positive electrode active material and is represented by the following composition formula (1):
LiₐA_{b}Mn_{2-x-y}M¹ₓM²_{y}O_{4-δ} (1)
(wherein, in the composition formula (1), M¹ is at least one element of Ni and Co, M¹ is at least one element selected from the group consisting of Al, Mg, Ca, Ti, Cr, Fe, Cu, Zn, La, Ce, Er, and Li, A is at least one element selected from the group consisting of Mg, Al, Nb, Ta, Ni, Mn, and Co, and 0≤a≤2−b, 0≤b≤0.15, 0.4≤x≤1.1, 0≤y≤0.55, and 0≤δ≤0.5).

3. The electrode for the non-aqueous electrolyte secondary battery according to claim 2, wherein, in the composition formula (1), when a=1, a ratio of Mn³⁺ to the total amount of Mn in the electrode is 6% or less, and when an X-ray diffraction pattern of the electrode when a=1 that is attributed to the electrode active material is indexed by space group P4₃32, a ratio I₍₁₁₀₎/I₍₁₂₀₎ of the intensity I₍₂₂₀₎ of the peak attributed to (220) to the intensity I₍₁₁₀₎ of the peak attributed to (110) is less than 1.

4. The electrode for a non-aqueous electrolyte secondary battery according to claim 1, wherein the solid electrolyte comprises a sulfide-based solid electrolyte.

5. A non-aqueous electrolyte secondary battery comprising a positive electrode, a negative electrode, and a separator or a solid electrolyte layer interposed between the positive electrode and the negative electrode,
wherein at least one of the positive electrode and the negative electrode is the electrode for the non-aqueous electrolyte secondary battery according to claim 1.
